(19) United States
(12) Patent Application Publication
(10) Pub. No.: US 2025/0106815 A1
(43) Pub. Date: Mar. 27, 2025

(54) METHODS AND APPARATUSES FOR SIDELINK POSITIONING MEASUREMENT AND REPORTING

(71) Applicant: LENOVO (BEIJING) LIMITED, Beijing (CN)

(72) Inventors: Jie HU, Beijing (CN); Jing HAN, Beijing (CN); Haiming WANG, Beijing (CN); Lianhai WU, Beijing (CN); Xiaodong YU, Beijing (CN)

(21) Appl. No.: 18/832,774

(22) PCT Filed: Jan. 25, 2022
(86) PCT No.: PCT/CN2022/073886

§ 371 Date: Jul. 24, 2024

(51) Int. Cl. H04W 64/00

(52) U.S. Cl. CPC H04W 64/006

(57) ABSTRACT

Disclosed are methods and apparatuses for sidelink (SL) positioning measurement and reporting. An embodiment of the subject application provides a first user equipment (UE). The first UE includes: a processor configured to perform a positioning measurement procedure to obtain location information associated with the first UE based on SL positioning reference signal transmission(s) between the first UE and a set of second UEs; and a transmitter coupled with the processor and configured to transmit a first report to a network entity based on the positioning measurement procedure.

### TECHNICAL FIELD

The present disclosure generally relates to wireless communication technologies, and especially relates to methods and apparatuses for sidelink (SL) positioning measurement and reporting.

### BACKGROUND

In legacy new radio (NR) positioning, the term “location information” or “position information” applies to both an actual location (or position) estimate and value(s) used for computing a position (e.g., radio measurements or positioning measurements). The location information may be delivered either in response to a request or unsolicitedly. The purpose of location information transfer procedures is to enable the request and delivery of location measurement data and/or a location estimate between a user equipment (UE) and a network entity (e.g., a location management function (LMF) or a base station (BS)), or between a BS (for example, a next generation radio access network (NG-RAN) node) and an LMF.

SL positioning refers to transmitting positioning reference signal (PRS) over SL, which can operate independently of network or radio access technology (RAT) coverage and provide a new positioning method that fits new network use cases. For SL positioning, SL-PRS transmission/reception is performed between a target UE and at least one anchor UE to help the target UE to acquire positioning results. Measurement and reporting procedures for SL positioning need to be defined.

### SUMMARY

Various embodiments of the present disclosure provide solutions related to SL positioning measurement and reporting.

According to some embodiments of the present disclosure, a first UE is provided. The first UE includes: a processor configured to perform a positioning measurement procedure to obtain location information associated with the first UE based on SL positioning reference signal (PRS) transmission(s) between the first UE and a set of second UEs; and a transmitter coupled with the processor and configured to transmit a first report to a network entity based on the positioning measurement procedure.

In some embodiments, to perform the positioning measurement procedure, the processor is configured to obtain the location information from SL-PRS measurement result(s) received from the set of second UEs.

In some embodiments, to perform the positioning measurement procedure, the processor is configured to perform measurement on SL-PRS transmission(s) received from the set of second UEs.

In some embodiments, the first UE further includes a receiver coupled to the processor and configured to receive a first location information request from the network entity, wherein the first location information request includes a first measurement configuration that includes at least one positioning measurement parameter indicating requested position measurement(s).

In some embodiments, the first measurement configuration further includes an anchor measurement list that includes the set of second UEs.

In some embodiments, the anchor measurement list includes all or a part of determined second UEs for the first UE.

In some embodiments, the first measurement configuration further includes mapping relationship between each of the set of second UEs and the at least one positioning measurement parameter, and the transmitter is further configured to transmit a second location information request to each of the set of second UEs according to the mapping relationship, wherein the second location information request transmitted to a second UE includes a second measurement configuration including positioning measurement parameter(s) mapped to the second UE.

In some embodiments, the processor is further configured to determine positioning measurement parameter(s) for each of the set of second UEs included in the anchor measurement list according to a pre-configuration, or a system information block, or the first UE's implementation; and the transmitter is further configured to transmit a second location information request to each of the set of second UEs included in the anchor measurement list, wherein the second location information request transmitted to a second UE includes a second measurement configuration including positioning measurement parameter(s) determined for the second UE.

In some embodiments, the processor is further configured to determine the set of second UEs and determine positioning measurement parameter(s) for each of the set of second UEs determined by the first UE according to a pre-configuration, or a system information block, or the first UE's implementation; and the transmitter is further configured to transmit a second location information request to each of the set of second UEs determined by the first UE, wherein the second location information request transmitted to a second UE includes a second measurement configuration including positioning measurement parameter(s) determined for the second UE.

In some embodiments, the transmitter is configured to transmit the first report each time when at least one requested position measurement is received from a second UE of the set of second UEs within a response duration, wherein the first report includes the at least one requested position measurement and an identifier (ID) associated with the second UE.

In some embodiments, the transmitter is configured to transmit the first report when a configured number of requested position measurements are received from the set of second UEs within a response duration.

In some embodiments, the first report includes each requested position measurement of the configured number of requested position measurements with an ID associated with a corresponding second UE from which the respective requested position measurement is received.

In some embodiments, the first report includes a location estimate determined based at least in part on the configured number of requested position measurements.

In some embodiments, the configured number of requested position measurements include all of the position measurement(s) requested by the first location information request.

In some embodiments, the processor is further configured to start a response timer with a length corresponding to a response duration for each second UE of the set of second UEs respectively when the second location information request is transmitted from the first UE to the respective second UE.

In some embodiments, the processor is further configured to stop the response timer for a second UE of the set of second UEs in response to reception of a second report including at least one requested position measurement or an error indication from the second UE.

In some embodiments, the first report includes a first error indication with a cause value when at least one of the following conditions is met: the first UE fails to configure any of the requested position measurement(s) for any of the set of second UEs, or the first UE receives a second error indication from each of the set of second UEs, or the first UE fails to receive any of the requested position measurement(s) from any of the set of second UEs within a response duration.

In some embodiments, the first report includes at least one requested position measurement received from at least one second UE of the set of second UEs within a response duration and at least one cause value for other second UE(s) of the set of second UEs when at least one of the following conditions is met: the first UE fails to receive any of the requested position measurement(s) from the other second UE(s) within the response duration, or the first UE receives an error indication from any of the other second UE(s).

In some embodiments, the receiver is further configured to receive an abort indication from the network entity to abort the positioning measurement procedure.

In some embodiments, the transmitter is further configured to transmit the abort indication to the set of second UEs.

In some embodiments, the receiver is further configured to receive at least one abort indication from at least one second UE of the set of second UEs to abort an on-going measurement procedure between the first UE and the at least one second UE.

In some embodiments, the transmitter is further configured to transmit the at least one abort indication to the network entity.

In some embodiments, the processor is further configured to determine to abort at least one on-going measurement procedure between the first UE and at least one second UE of the set of second UEs; and the transmitter is further configured to transmit an abort message including at least one ID associated with the at least one on-going measurement procedure to at least one of the network entity or the at least one second UE.

In some embodiments, the at least one on-going measurement procedure is per SL unicast link, per SL destination, or per quality of service (QOS) requirement for positioning service.

In some embodiments, the first report includes a first error indication with a cause value when at least one of the following conditions is met: the first measurement configuration is incompatible with a UE capability or other configuration(s) of the first UE, or the first UE fails to acquire all or at least one of the requested position measurement(s) within a response duration.

In some embodiments, the first report includes at least one requested position measurement acquired within a response duration and at least one cause value for other requested position measurement(s) when at least one of the following conditions is met: the other requested position measurement(s) is (are) incompatible with a UE capability or other configuration(s) of the first UE, or the first UE fails to acquire any of the other requested position measurement(s) within the response duration.

In some embodiments, the receiver is further configured to receive an indication from the network entity indicating a release or update of a positioning measurement configuration for a second UE of the set of second UEs.

In some embodiments, the first report is transmitted in a mobile originating location request.

According to some embodiments of the present disclosure, a second UE is provided. The second UE includes: a processor configured to perform a positioning measurement procedure to obtain location information associated with a first UE based on SL-PRS transmission(s) between the first UE and the second UE; and a transmitter coupled with the processor and configured to transmit a report based on the positioning measurement procedure.

In some embodiments, to perform the positioning measurement procedure, the processor is configured to perform measurement on SL-PRS transmission(s) received from the first UE.

In some embodiments, the second UE further includes a receiver coupled to the processor and configured to receive a location information request requesting the second UE to perform the positioning measurement procedure, wherein the location information request includes a measurement configuration including positioning measurement parameter(s) indicating requested position measurement(s).

In some embodiments, the location information request is received from the first UE or from a network entity.

In some embodiments, the report includes at least one of the requested position measurement(s).

In some embodiments, the report further includes at least one cause value for the requested position measurement(s) not included in the report.

In some embodiments, the report includes an error indication with a cause value when at least one of the following conditions is met: the measurement configuration is incompatible with a UE capability or other configuration(s) of the second UE, or the second UE fails to acquire all or at least one of the requested position measurement(s) within a response duration.

In some embodiments, the location information request is received from the first UE, and the transmitter is further configured to transmit the measurement configuration to a network entity.

In some embodiments, the location information request is received from a network entity and further indicates a reporting entity for receiving the report from the second UE, wherein the reporting entity is the network entity or the first UE.

In some embodiments, the receiver is further configured to receive an abort indication to abort the positioning measurement procedure between the first UE and the second UE.

In some embodiments, the transmitter is further configured to transmit, to a network entity, an abort message including an ID associated with the positioning measurement procedure in the case that the abort indication is received from the first UE.

According to some embodiments of the present disclosure, a network entity is provided. The network entity includes: a receiver configured to receive at least one report from at least one UE, wherein the at least one report is based on a positioning measurement procedure for obtaining location information associated with a first UE based on SL-PRS transmission(s) between the first UE and a set of second UEs; and a processor coupled with the receiver.

In some embodiments, the network entity further includes a transmitter coupled with the processor and configured to transmit at least one location information request to the at least one UE, wherein each location information request includes a measurement configuration that includes at least one positioning measurement parameter indicating requested position measurement(s).

In some embodiments, the at least one report is received within a response duration and includes at least one of the requested position measurement(s).

In some embodiments, the processor is further configured to calculate a position result for the first UE based on the at least one report.

In some embodiments, the processor is configured to start a response timer with a length corresponding to a response duration for each UE of the at least one UE when the at least one location information request is transmitted from the network entity.

In some embodiments, the processor is further configured to stop the response timer for a UE in response to reception of a report from the UE including at least one requested position measurement or an error indication.

In some embodiments, the at least one UE includes the first UE, and the measurement configuration for the first UE further includes an anchor measurement list that includes at least one second UE of the set of second UEs.

In some embodiments, the measurement configuration for the first UE further includes mapping relationship between each of the at least one second UE and the at least one positioning measurement parameter included in the measurement configuration for the first UE.

In some embodiments, the at least one UE includes a second UE of the set of second UEs, and the location information request transmitted to the second UE indicates a reporting entity for receiving a report in response to the location information request from the second UE, wherein the location reporting entity is the network entity or the first UE.

In some embodiments, the processor is further configured to determine to abort the positioning measurement procedure; the transmitter is further configured to transmit an abort indication to the at least one UE; and the processor is further configured to release the measurement configuration for each of the at least one UE.

In some embodiments, the receiver is further configured to receive an abort message from a UE of the at least one UE including at least one ID associated with at least one on-going measurement procedure.

In some embodiments, the at least one on-going measurement procedure is per SL unicast link, per SL destination, or per QoS requirement for positioning service.

In some embodiments, the at least one UE includes a second UE of the set of second UEs; the processor is configured to determine to release or update the measurement configuration for the second UE; and the transmitter is further configured to transmit an indication to the first UE indicating the release or update of the measurement configuration for the second UE.

In some embodiments, in the case that the at least one report includes an error indication from a UE with a cause value, the processor is configured to terminate the positioning measurement procedure and release the measurement configuration for each of the at least one UE.

According to some embodiments of the present disclosure, a method performed by a first UE is provided. The method includes: performing a positioning measurement procedure to obtain location information associated with the first UE based on SL-PRS transmission(s) between the first UE and a set of second UEs; and transmitting a first report to a network entity based on the positioning measurement procedure.

In some embodiments, performing the positioning measurement procedure includes obtaining the location information from SL-PRS measurement result(s) received from the set of second UEs.

In some embodiments, performing the positioning measurement procedure includes performing measurement on SL-PRS transmission(s) received from the set of second UEs.

In some embodiments, the method further includes receiving a first location information request from the network entity, wherein the first location information request includes a first measurement configuration that includes at least one positioning measurement parameter indicating requested position measurement(s).

In some embodiments, the first measurement configuration further includes an anchor measurement list that includes the set of second UEs.

In some embodiments, the anchor measurement list includes all or a part of determined second UEs for the first UE.

In some embodiments, the first measurement configuration further includes mapping relationship between each of the set of second UEs and the at least one positioning measurement parameter, and the method further includes transmitting a second location information request to each of the set of second UEs according to the mapping relationship, wherein the second location information request transmitted to a second UE includes a second measurement configuration including positioning measurement parameter(s) mapped to the second UE.

In some embodiments, the method further includes: determining positioning measurement parameter(s) for each of the set of second UEs included in the anchor measurement list according to a pre-configuration, or a system information block, or the first UE's implementation; and transmitting a second location information request to each of the set of second UEs included in the anchor measurement list, wherein the second location information request transmitted to a second UE includes a second measurement configuration including positioning measurement parameter(s) determined for the second UE.

In some embodiments, the method further includes: determining the set of second UEs and determining positioning measurement parameter(s) for each of the set of second UEs determined by the first UE according to a pre-configuration, or a system information block, or the first UE's implementation; and transmitting a second location information request to each of the set of second UEs determined by the first UE, wherein the second location information request transmitted to a second UE includes a second measurement configuration including positioning measurement parameter(s) determined for the second UE.

In some embodiments, the method further includes transmitting the first report each time when at least one requested position measurement is received from a second UE of the set of second UEs within a response duration, wherein the first report includes the at least one requested position measurement and an ID associated with the second UE.

In some embodiments, the method further includes transmitting the first report when a configured number of requested position measurements are received from the set of second UEs within a response duration.

In some embodiments, the first report includes each requested position measurement of the configured number of requested position measurements with an ID associated with a corresponding second UE from which the respective requested position measurement result is received.

In some embodiments, the first report includes a location estimate determined based at least in part on the configured number of requested position measurements.

In some embodiments, the configured number of requested position measurements include all of the position measurement(s) requested by the first location information request.

In some embodiments, the method further includes starting a response timer with a length corresponding to a response duration for each second UE of the set of second UEs respectively when the second location information request is transmitted from the first UE to the respective second UE.

In some embodiments, the method further includes stopping the response timer for a second UE of the set of second UEs in response to reception of a second report including at least one requested position measurement or an error indication from the second UE.

In some embodiments, the first report includes a first error indication with a cause value when at least one of the following conditions is met: the first UE fails to configure any of the requested position measurement(s) for any of the set of second UEs, the first UE receives a second error indication from each of the set of second UEs, or the first UE fails to receive any of the requested position measurement(s) from any of the set of second UEs within a response duration.

In some embodiments, the first report includes at least one requested position measurement received from at least one second UE of the set of second UEs within a response duration and at least one cause value for other second UE(s) of the set of second UEs when at least one of the following conditions is met: the first UE fails to receive any of the requested position measurement(s) from the other second UE(s) within the response duration, or the first UE receives an error indication from any of the other second UE(s).

In some embodiments, the method further includes receiving an abort indication from the network entity to abort the positioning measurement procedure.

In some embodiments, the method further includes transmitting the abort indication to the set of second UEs.

In some embodiments, the method further includes receiving at least one abort indication from at least one second UE of the set of second UEs to abort an on-going measurement procedure between the first UE and the at least one second UE.

In some embodiments, the method further includes transmitting the at least one abort indication to the network entity.

In some embodiments, the method further includes: determining to abort at least one on-going measurement procedure between the first UE and at least one second UE of the set of second UEs; and transmitting an abort message including at least one ID associated with the at least one on-going measurement procedure to at least one of the network entity or the at least one second UE.

In some embodiments, the at least one on-going measurement procedure is per SL unicast link, per SL destination, or per quality of service (QOS) requirement for positioning service.

In some embodiments, the first report includes a first error indication with a cause value when at least one of the following conditions is met: the first measurement configuration is incompatible with a UE capability or other configuration(s) of the first UE, or the first UE fails to acquire all or at least one of the requested position measurement(s) within a response duration.

In some embodiments, the first report includes at least one requested position measurement acquired within a response duration and at least one cause value for other requested position measurement(s) when at least one of the following conditions is met: the other requested position measurement(s) is (are) incompatible with a UE capability or other configuration(s) of the first UE, or the first UE fails to acquire any of the other requested position measurement(s) within the response duration.

In some embodiments, the method further includes receiving an indication from the network entity indicating a release or update of a positioning measurement configuration for a second UE of the set of second UEs.

In some embodiments, the first report is transmitted in a mobile originating location request.

According to some embodiments of the present disclosure, a method performed by a second UE is provided. The method includes: performing a positioning measurement procedure to obtain location information associated with a first UE based on SL-PRS transmission(s) between the first UE and the second UE; and transmitting a report based on the positioning measurement procedure.

In some embodiments, performing the positioning measurement procedure includes performing measurement on SL-PRS transmission(s) received from the first UE.

In some embodiments, the method further includes receiving a location information request requesting the second UE to perform the positioning measurement procedure, wherein the location information request includes a measurement configuration including positioning measurement parameter(s) indicating requested position measurement(s).

In some embodiments, the location information request is received from the first UE or from a network entity.

In some embodiments, the report includes at least one of the requested position measurement(s).

In some embodiments, the report further includes at least one cause value for the requested position measurement(s) not included in the report.

In some embodiments, the report includes an error indication with a cause value when at least one of the following conditions is met: the measurement configuration is incompatible with a UE capability or other configuration(s) of the second UE, or the second UE fails to acquire all or at least one of the requested position measurement(s) within a response duration.

In some embodiments, the location information request is received from the first UE, and the transmitter is further configured to transmit the measurement configuration to a network entity.

In some embodiments, the location information request is received from a network entity and further indicates a reporting entity for receiving the report from the second UE, wherein the reporting entity is the network entity or the first UE.

In some embodiments, the method further includes receiving an abort indication to abort the positioning measurement procedure between the first UE and the second UE.

In some embodiments, the method further includes transmitting, to a network entity, an abort message including an ID associated with the positioning measurement procedure in the case that the abort indication is received from the first UE.

According to some embodiments of the present disclosure, a method performed by a network entity is provided. The method includes: receiving at least one report from at least one UE, wherein the at least one report is based on a positioning measurement procedure for obtaining location information associated with a first UE based on SL-PRS transmission(s) between the first UE and a set of second UEs.

In some embodiments, the method further includes transmitting at least one location information request to the at least one UE, wherein each location information request includes a measurement configuration that includes at least one positioning measurement parameter indicating requested position measurement(s).

In some embodiments, the at least one report is received within a response duration and includes at least one of the requested position measurement(s).

In some embodiments, the method further includes calculating a position result for the first UE based on the at least one report.

In some embodiments, the method further includes starting a response timer with a length corresponding to a response duration for each UE of the at least one UE when the at least one location information request is transmitted from the network entity.

In some embodiments, the method further includes stopping the response timer for a UE in response to reception of a report from the UE including at least one requested position measurement or an error indication.

In some embodiments, the at least one UE includes the first UE, and the measurement configuration for the first UE further includes an anchor measurement list that includes at least one second UE of the set of second UEs.

In some embodiments, the measurement configuration for the first UE further includes mapping relationship between each of the at least one second UE and the at least one positioning measurement parameter included in the measurement configuration for the first UE.

In some embodiments, the at least one UE includes a second UE of the set of second UEs, and the location information request transmitted to the second UE indicates a reporting entity for receiving a report in response to the location information request from the second UE, wherein the location reporting entity is the network entity or the first UE.

In some embodiments, the method further includes: determining to abort the positioning measurement procedure; transmitting an abort indication to the at least one UE; and releasing the measurement configuration for each of the at least one UE.

In some embodiments, the method further includes receiving an abort message from a UE of the at least one UE including at least one ID associated with at least one on-going measurement procedure.

In some embodiments, the at least one on-going measurement procedure is per SL unicast link, per SL destination, or per QoS requirement for positioning service.

In some embodiments, the at least one UE includes a second UE of the set of second UEs; and the method further includes: determining to release or update the measurement configuration for the second UE; and transmitting an indication to the first UE indicating the release or update of the measurement configuration for the second UE.

In some embodiments, in the case that the at least one report includes an error indication from a UE with a cause value, the method further includes terminating the positioning measurement procedure and releasing the measurement configuration for each of the at least one UE.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary scenario according to some embodiments of the present disclosure;

FIG. 2 illustrates another exemplary scenario according to some other embodiments of the present disclosure;

FIG. 3 illustrates a flow chart of an exemplary method according to some embodiments of the present disclosure;

FIG. 4 illustrates a flow chart of another exemplary method according to some other embodiments of the present disclosure; and

FIG. 5 illustrates a simplified block diagram of an exemplary apparatus according to some embodiments of the present disclosure.

### DETAILED DESCRIPTION

The detailed description of the appended drawings is intended as a description of some embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) 5G NR, 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The present disclosure provides various methods and apparatuses regarding measurement and reporting procedures for network-based SL positioning. The positioning measurements are based on SL-PRS measurements performed between a target UE and at least one anchor UE, and the final positioning results are calculated at network side (e.g., a network entity or a location server).

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

According to some embodiments of the present disclosure, a target UE (also referred to as an SL target UE or a location service (LCS) target UE) may refer to a UE that wants to know its own position. An anchor UE (also referred to as an SL anchor UE) may refer to a UE that participates in SL positioning and helps a target UE to acquire its position, e.g., by sending or receiving SL PRS and doing relevant measurements. The anchor UE should have positioning capability, and may be a road side unit (RSU) or any SL UE.

According to some embodiments of the present disclosure, a target UE may participate in a positioning measurement procedure to obtain its location information based on SL-PRS transmission(s) between the target UE and a set of anchor UEs. The target UE may obtain the location information from SL-PRS measurement result(s) received from the set of anchor UEs. Additionally or alternatively, the target UE may perform measurement on SL-PRS transmission(s) received from the set of anchor UEs.

According to some embodiments of the present disclosure, an anchor UE may participate in a positioning measurement procedure to obtain location information associated with a target UE based on SL-PRS transmission(s) between the target UE and the anchor UE. The anchor UE may perform measurement on SL-PRS transmission(s) received from the target UE. Additionally or alternatively, the anchor UE may transmit SL PRS to the target UE.

According to some embodiments of the present disclosure, a UE (e.g., a target UE or an anchor UE) may include a vehicle UE (VUE) or a power-saving UE (also referred to as a power sensitive UE). The power-saving UE may include a vulnerable road user (VRU), a public safety UE (PS-UE), or a commercial sidelink UE (CS-UE) that is sensitive to power consumption. The VRU may include a pedestrian UE (P-UE), a cyclist UE, a wheelchair UE or any other UE which requires power saving compared with a VUE.

According to some embodiments of the present disclosure, a UE (e.g., a target UE or an anchor UE) may include a computing device, such as a desktop computer, a laptop computer, a personal digital assistant (PDA), a tablet computer, a smart television (e.g., a television connected to the Internet), a set-top box, a game console, a security system (including a security camera), a vehicle on-board computer, a network device (e.g., a router, a switch, or a modem), or the like.

According to some embodiments of the present disclosure, a UE (e.g., a target UE or an anchor UE) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, a UE (e.g., a target UE or an anchor UE) may include a wearable device, such as a smart watch, a fitness band, an optical head-mounted display, or the like.

Moreover, a UE (e.g., a target UE or an anchor UE) may be referred to as a subscriber unit, a mobile, a mobile station, a user, a terminal, a mobile terminal, a wireless terminal, a fixed terminal, a subscriber station, a user terminal, or a device, or described using other terminology used in the art.

According to some embodiments of the present disclosure, a UE and an LMF may coordinate positioning related information by LTE positioning protocol (LPP) signaling, a BS and an LMF may coordinate positioning related information by NR positioning protocol A (NRPPa) signaling, and a UE and a BS may coordinate positioning related information by radio resource control (RRC) signaling.

The BS may also be referred to as an access point, an access terminal, a base, a macro cell, a node-B, an enhanced node B (eNB), a gNB, a home node-B, a relay node, or a device, or described using other terminology used in the art. The BS is generally part of a radio access network that may include a controller communicably coupled to the BS.

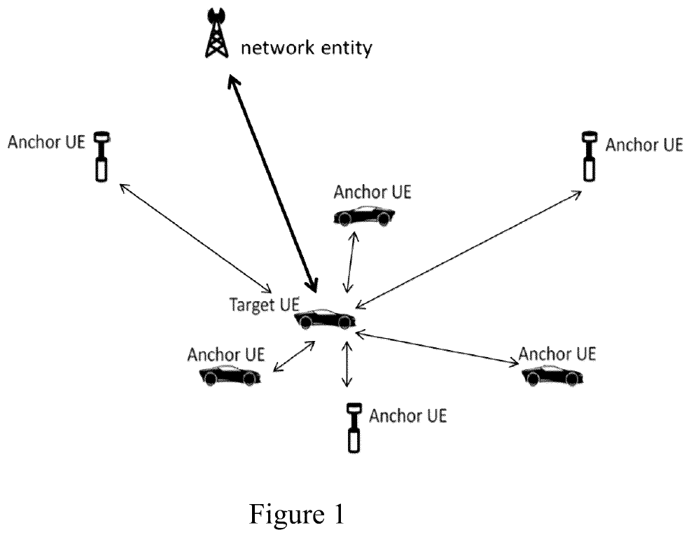

FIG. 1 illustrates an exemplary schematic diagram for scenario 1 where some embodiments of the present disclosure may be implemented.

In scenario 1, a positioning measurement procedure is initiated by a network entity for obtaining location information associated with a target UE. The network entity may be a BS, an LMF or an entity with similar functions.

The network entity may transmit a location information request to a target UE for obtaining location information associated with the target UE. In some cases, an LMF may transmit a location information request via LPP signaling to the target UE. In some cases, a BS may transmit a location information request via RRC signaling to the target UE. In some cases, an LMF may indicate a positioning service to a BS by transmitting a location information request via NRPPa signaling to the BS, and the BS may further transfer a location information request via RRC signaling to the target UE. In other words, the location information request may be determined by the BS according to the indicated positioning service from the LMF.

According to some embodiments of the present disclosure, the location information request may include a measurement configuration that includes at least one positioning measurement parameter indicating requested position measurement(s). The at least one positioning measurement parameter may include but are not limited to one or more of the following parameters:
Type(s) of measured parameter(s): e.g., reference signal received power (RSRP), angle-of-departure (AOD), round trip time (RTT), etc. (associated with positioning method(s) to be performed);
Type(s) of location information needed: e.g., required or preferred location estimate(s), required or preferred location measurement result(s), etc.;
SL-PRS transmission window: e.g., start time point, valid time or stop time point for SL-PRS transmission or reception, etc.;
Measurement reporting event(s): e.g., on-demand reporting, periodic reporting, triggered reporting, etc.;
Service QoS requirement(s): e.g., horizontal or vertical accuracy, response time (e.g., the maximum response time between receipt of a location information request and transmission of a corresponding location information response), etc.;
Additional assistance information if any, e.g., velocity, carrier phase, multi-frequency measurement, etc.

After receiving the location information request, the target UE may transmit at least one location information request to a set of anchor UEs. Each location information request may include a measurement configuration including positioning measurement parameter(s) for a respective anchor UE. The anchor UE(s) may be determined by a network entity (e.g., LMF or BS) or selected by the target UE itself before performing SL-PRS transmission or reception. In the case that the anchor UE(s) is (are) determined by the network entity, the anchor UE(s) may be served by the same BS as the target UE. In the case that the anchor UE(s) is (are) selected by the target UE itself, the anchor UE(s) may be in coverage or out of coverage of a network, and may be served by the same BS as the target UE or by a different BS.

SL-PRS transmission(s) may be performed between the target UE and the set of anchor UEs before or after the target UE receives the location information request from the network entity. Each anchor UE may perform position measurement based on the SL-PRS transmission(s) between the anchor UE and the target UE when the measurement configuration included in the location information request received from the target UE is compatible with the anchor UE's capability and other configuration(s). The anchor UE may transmit a report (or response message) including at least one requested position measurement(s) (also referred to as position measurement result(s)) to the target UE.

The target UE then may transmit a report (or response message) including the received position measurement result(s) to the network entity. For example, the target UE may transmit the report to an LMF via LPP signaling, or to a BS via RRC signaling. The network entity may calculate positioning result(s) based on the received position measurement result(s). Alternatively or additionally, the network entity may transmit the received position measurement result(s) to a server (e.g., an LCS server) for calculating the positioning result(s), and receive the positioning result(s) from the server.

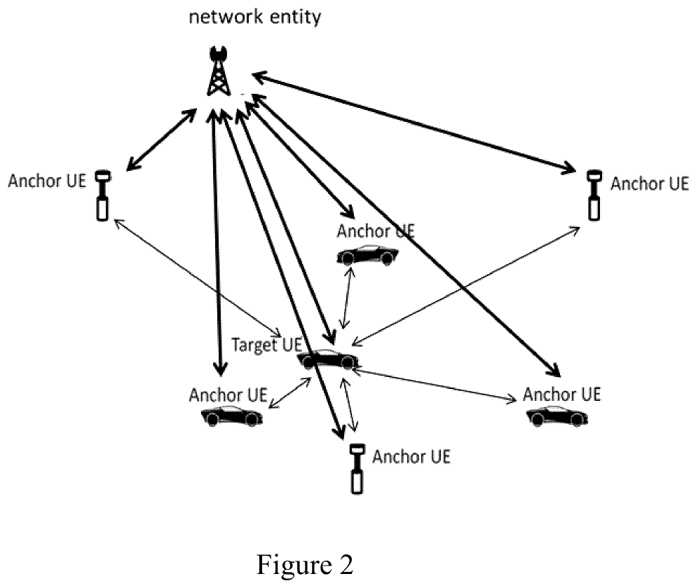

FIG. 2 illustrates an exemplary schematic diagram for scenario 2 where some embodiments of the present disclosure may be implemented.

In scenario 2, a positioning measurement procedure for obtaining location information associated with a target UE is initiated by a network entity, e.g., an LMF or a BS.

The network entity may transmit a location information request to a target UE for obtaining location information associated with the target UE. The BS may also transmit a location information request to each of a set of anchor UEs for obtaining location information associated with the target UE. In some cases, an LMF may transmit a location information request via LPP signaling to the target UE and anchor UE(s). In some cases, a BS may transmit a location information request via RRC signaling to the target UE and anchor UE(s). In some cases, an LMF may indicate a positioning service to a BS by transmitting a location information request via NRPPa signaling to the BS, and the BS may further transfer a location information request via RRC signaling to the target UE and anchor UE(s). In other words, the location information request may be determined by the BS according to the indicated positioning service from the LMF. Thus, scenario 2 only applies in the case that the target UE and the set of anchor UEs are in coverage of the same network and information of the set of anchor UEs is known to the network entity. According to some embodiments of the present disclosure, each location information request may include a measurement configuration that includes at least one positioning measurement parameter indicating requested position measurement(s). The at least one positioning measurement parameter may include but are not limited to one or more of the following parameters:
Type(s) of measured parameter(s): e.g., RSRP, AOD, RTT, etc. (associated with positioning method(s) to be performed);
Type(s) of location information needed: e.g., required or preferred location estimate(s), required or preferred location measurement result(s), etc.;
SL-PRS transmission window: e.g., start time point, valid time or stop time point for SL-PRS transmission or reception, etc.;
Measurement reporting event(s): e.g., on-demand reporting, periodic reporting, triggered reporting, etc.;
Service QoS requirement(s): e.g., horizontal or vertical accuracy, response time (e.g., the maximum response time between receipt of a location information request and transmission of a corresponding location information response), etc.;
Additional assistance information if any, e.g., velocity, carrier phase, multi-frequency measurement, etc.

SL-PRS transmission(s) may be performed between the target UE and the set of anchor UEs before or after the target UE and/or anchor UE(s) receives the location information request from the network entity. The target UE and/or anchor UE(s) may perform position measurement based on the SL-PRS transmission(s) when the measurement configuration included in the location information request received from the network entity is compatible with the target UE and/or anchor UE(s)'s capability and other configuration(s).

The target UE may transmit a report (or response message) including its position measurement result(s) to the network entity.

The anchor UE(s) may transmit a report (or response message) including their position measurement result(s) to the network entity. Alternatively or additionally, the anchor UE(s) may transmit the report including their position measurement result(s) to the target UE when the location information request received from the network entity indicates that a reporting entity for receiving the report is the target UE. In the case that the anchor UE(s) report their position measurement result(s) to the target UE, the target UE may transmit a report (or response message) including the received position measurement result(s) together with its own position measurement result(s) to the network entity.

The network entity may calculate positioning result(s) based on the received position measurement result(s). Alternatively or additionally, the network entity may transmit the received position measurement result(s) to a server (e.g., an LCS server) for calculating the positioning result(s), and receive the positioning result(s) from the server.

More details of embodiments of the present disclosure will be described below with respect to each of scenario 1 and scenario 2.

### Scenario 1

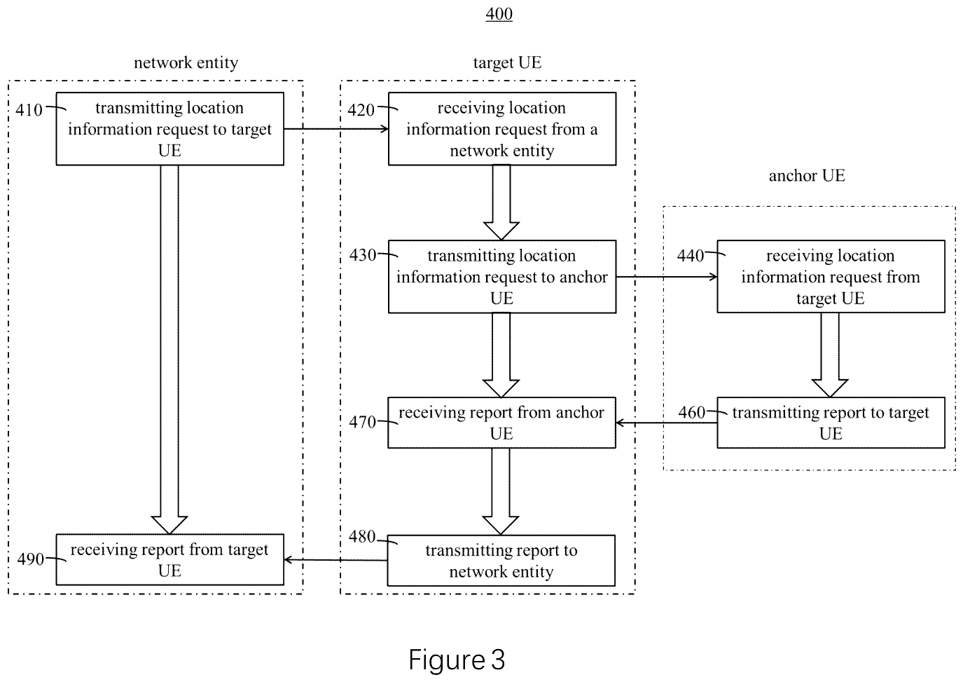

FIG. 3 illustrates a flow chart of an exemplary method 400 for SL positioning measurement and reporting in scenario 1 according to some embodiments of the present disclosure. Although method 400 performed by a target UE, an anchor UE, and a network entity is illustrated in a system level, persons skilled in the art can understand that the part of method 400 implemented in the target UE, the part of method 400 implemented in the anchor UE, and the part of method 400 implemented in the network entity can be separately implemented and incorporated in other apparatus with the like functions.

It would be appreciated that a target UE shown in method 400 or in other methods described as below may not be a special SL UE. For example, the target UE may be a generic device or apparatus with SL features (also referred to as SL device or SL apparatus), or a part of an SL device or an SL apparatus that uses the technical solutions of the present application. It would be also appreciated that an anchor UE shown in method 400 or in other methods described as below may not be a special SL UE. For example, the anchor UE may be a generic SL device or SL apparatus, or a part of an SL device or an SL apparatus that uses the technical solutions of the present application.

Referring to FIG. 3, in operation 410, the network entity may initiate a positioning measurement procedure for obtaining location information associated with a target UE by transmitting a location information request (also referred to as a first location information request) to the target UE, wherein the first location information request may include a measurement configuration (also referred to as a first measurement configuration) that includes at least one positioning measurement parameter indicating requested position measurement(s).

In an embodiment, the network entity is a BS, and the first location information request is transmitted from the BS to the target UE via an RRC message. In another embodiment, the network entity is an LMF, and the first location request is transmitted from the LMF to the target UE via an LPP message.

Accordingly, in operation 420, the target UE may receive the first location information request from the network entity.

In operation 430, the target UE may transmit a location information request (also referred to as a second location information request) to each of a set of anchor UEs based on information included in the first location information request received from the network entity. In an embodiment, a target UE may transmit a location information request to each of set of anchor UE when the first location information request from the network entity to the target UE indicates the measured location information of anchor UE(s) is requested. Although only one of the set of anchor UEs is shown in FIG. 3, it is contemplated that any number of anchor UEs may be involved in method 400 and perform similar operations. Although not shown in FIG. 3, it is understood that SL-PRS transmission(s) may be performed between the target UE and the set of anchor UEs before or after the target UE receives the first location information request from the network entity. The SL-PRS transmission may be from the target UE to an anchor UE or from an anchor UE to the target UE. The target UE and/or the anchor UE(s) may perform measurement based on the SL-PRS transmission(s) to obtain location information associated with the target UE.

In some embodiments, the first measurement configuration included in the first location information request received from the network entity may include an anchor measurement list including a list of anchor UEs and mapping relationship between each of the list of anchor UEs and the at least one positioning measurement parameter included in the first measurement configuration. The list of anchor UEs may include a specified number of anchor UEs determined by the network entity. Each anchor UE may be represented by an associated ID, e.g., layer 2 ID, destination ID, pre-defined index, etc. In an embodiment, the list of anchor UEs may include all anchor UEs for the target UE that are determined by the network entity or the target UE for SL positioning. In another embodiment, the list of anchor UEs may include only a part of the determined anchor UEs for the target UE. For example, the list of anchor UEs may include the anchor UE(s) out of network coverage. The network entity may directly configure the anchor UE(s) not included in the list in a manner similar to the methods which will be described below with respect to scenario 2.

In these embodiments, the target UE may transmit the second location information request to each of the list of anchor UEs according to the mapping relationship, wherein the second location information request transmitted to an anchor UE may include a measurement configuration (also referred to as a second measurement configuration) including positioning measurement parameter(s) mapped to the anchor UE as indicated by the mapping relationship. In some embodiments, the second measurement configuration may be included in the first measurement configuration, and according to the mapping relationship, the target UE may transfer the second measurement configuration to a corresponding anchor UE without decoding it.

In some embodiments, the first measurement configuration included in the first location information request received from the network entity may include the anchor measurement list but does not include the mapping relationship between each anchor UE in the anchor measurement list and the at least one positioning measurement parameter included in the first measurement configuration. In these embodiments, the target UE may decode the first measurement configuration and determine positioning measurement parameter(s) for each anchor UE included in the anchor measurement list according to a pre-configuration, or a system information block, or the target UE's implementation. Then, the target UE may transmit the second location information request to each anchor UE included in the anchor measurement list, wherein the second location information request transmitted to an anchor UE may include a second measurement configuration including positioning measurement parameter(s) determined for the anchor UE.

In some embodiments, the first measurement configuration included in the first location information request received from the network entity may not include the anchor measurement list. In these embodiments, the target UE may determine the set of anchor UEs to which the second location information request will be transmitted. The set of anchor UEs may include a part or all the anchor UEs for the target UE that are determined by the network entity or the target UE for SL positioning. Then, the target UE may determine positioning measurement parameter(s) for each of the set of anchor UEs according to a pre-configuration, or a system information block, or the target UE's implementation, and may transmit the second location information request to each of the set of anchor UEs, wherein the second location information request transmitted to an anchor UE may include a second measurement configuration including positioning measurement parameter(s) determined for the anchor UE.

Accordingly, in operation 440, an anchor UE may receive the second location information request from the target UE. In some embodiments, for example, in the case that the anchor UE is not served by the network entity which transmits the first location information request, the anchor UE may transmit the second measurement configuration included in the second location information request to its serving network entity, e.g., to avoid receiving configuration(s) incompatible with the second measurement configuration from the serving network entity.

After receiving the second location information request, the anchor UE may perform location information measurement based on SL-PRS transmission(s) received from the target UE according to the second measurement configuration in the second location information request to obtain the requested position measurement(s) indicated by the positioning measurement parameter(s) included in the second measurement configuration, if the second measurement configuration is compatible with a UE capability and other configuration(s) of the anchor UE. In some embodiments, if the second measurement configuration is incompatible with the UE capability or other configuration(s) of the anchor UE, the anchor UE will not perform location information measurement according to the second measurement configuration. The second measurement configuration being incompatible may include part of the second measurement configuration being incompatible. In some other embodiments, when part of the second measurement configuration is compatible with the UE capability and other configuration(s) of the anchor UE while the rest is not, the anchor UE may perform location information measurement according to the compatible part of the second measurement configuration.

In operation 460, the anchor UE may transmit a report to the target UE.

In some embodiments, the report may include at least one requested position measurement acquired by the anchor UE. Such report may be referred to as a reporting or response message. In some embodiments, when the anchor UE cannot acquire part of the requested position measurement(s) indicated by the second measurement configuration (e.g., the part is incompatible with the UE capability or other configuration(s) of the anchor UE, or the anchor UE cannot acquire the part within a response duration which may be configured by the network entity or the target UE via the first location information request or the second location information request or the like or be pre-configured), the report may include both the requested position measurement(s) acquired by the anchor UE and at least one cause value for the requested position measurement(s) not included in the report. For example, each cause value may indicate why a corresponding position measurement is not included in the report.

In some embodiments, the report may include an error indication with a cause value. Such report may be referred to as a failure or error message. The failure or error message is transmitted by the anchor UE when at least one of the following conditions is met:
the measurement configuration is incompatible with a UE capability or other configuration(s) of the anchor UE, or
the anchor UE fails to acquire all or at least one of the requested position measurement(s) within a response duration (e.g., a response duration which may be configured by the network entity or the target UE via the first location information request or the second location information request or the like or be pre-configured).

Accordingly, in operation 470, the target UE may receive the report from the anchor UE. The target UE may also receive report(s) from other anchor UE(s). Then, in operation 480, the target UE may transmit a report (also referred to as a first report) to the network entity based on the report(s) received from the anchor UE(s). Accordingly, in operation 490, the network entity may receive the first report from the target UE.

In some embodiments, the target UE may transmit the first report to the network entity each time when at least one requested position measurement is received from an anchor UE (e.g., via a report received from the anchor UE) within a response duration. Such report may be referred to as a reporting or response message. In an embodiment, the response duration may be configured by the network entity via the first location information request or the like or be pre-configured. The first report may include the at least one requested position measurement and an ID associated with the anchor UE from which the at least one requested position measurement is received.

In some other embodiments, the target UE may transmit the first report to the network entity when a configured number of requested position measurements are received from the anchor UE(s) within a response duration. Such report may be referred to as a reporting or response message. In an embodiment, the response duration may be configured by the network entity via the first location information request or the like or be pre-configured. The configured number of requested position measurements may include part or all of the position measurement(s) requested by the first location information request.

In some embodiments, the first report may include each requested position measurement of the configured number of requested position measurements with an ID associated with a corresponding anchor UE from which the respective requested position measurement is received.

In some embodiments, the first report may additionally or alternatively include a location estimate determined by the target UE based at least in part on the configured number of requested position measurements received from the anchor UE(s) within the response duration.

In some embodiments, the first report may include both the requested position measurement(s) acquired by the target UE (e.g., the requested position measurement(s) received from anchor UE(s)) within a response duration (e.g., a response duration which may be configured by the network entity via the first location information request or the like or be pre-configured) and at least one cause value for at least one anchor UE when at least one of the following condition is met:
the target UE fails to receive any requested position measurement from the at least one anchor UE within the response duration, or.
the target UE receives an error indication from any of the at least one anchor UE.

For example, each cause value may indicate why a corresponding anchor UE does not transmit the requested position measurement(s). The first report may also include an ID associated with each anchor UE from which the requested position measurement(s) is (are) received within the response duration.

In some embodiments, the first report may include an error indication with a cause value when at least one of the following conditions is met:
the target UE fails to configure any of the requested position measurement(s) for any anchor UE included in the anchor measurement list or in the set of anchor UEs determined by the target UE,
the target UE receives an error indication from each anchor UE included in the anchor measurement list or in the set of anchor UEs determined by the target UE, or
the target UE fails to receive any of the requested position measurement(s) from any anchor UE included in the anchor measurement list or in the set of anchor UEs determined by the target UE within a response duration (e.g., a response duration which may be configured by the network entity via the first location information request or the like or be pre-configured).

In some embodiments, the network entity may start a first response timer with a length corresponding to a first response duration for the target UE when the network entity transmits the first location information request to the target UE. The network entity may stop the first response timer when the network entity receives a first report from the target UE which includes at least one requested position measurement or an error indication. The first response duration may be determined by the network entity or be pre-configured.

In some embodiments, the target UE may start a second response timer with a length corresponding to a second response duration for an anchor UE when the target UE transmits the second location information request to the anchor UE. The target UE may stop the second response timer for the anchor UE when the target UE receives a report from the anchor UE which includes at least one requested position measurement or an error indication. The target UE may set a separate response timer for each anchor UE to which the target UE transmits a second location information request. The initial length of all the anchor UE(s) may be the same. The second response duration may be pre-configured, configured by the network entity, or determined based on the first response duration for the target UE. For example, the network entity may transmit the first response duration to the target UE (e.g., via the first location information request or the like), and the UE may determine a duration shorter than the first response duration as the second response duration.

In some embodiments, when the second response timer for an anchor UE expires and no requested position measurement is received from the anchor UE by the target UE, the target UE may declare a measurement error or failure for the anchor UE. In an embodiment, the target UE may inform the measurement error or failure to the network entity (e.g., via an error indication) such that the network entity may stop the first response timer.

In some embodiments, when the first response timer for the target UE expires and no requested position measurement is received from the target UE by the network entity, the network entity may declare a measurement error or failure for the on-going measurement procedure.

In some embodiments, when periodical reporting is configured, the first response timer and/or the second response timer may be configured for the first reporting.

After receiving the first report including at least one requested positioning measurement, the network entity may calculate position result(s) for the target UE based on the received positioning measurement(s). Alternatively or additionally, the network entity may transmit the received position measurement(s) to a server (e.g., an LCS server) for calculating the positioning result(s), and receive the positioning result(s) from the server.

In some embodiments, in the case that the network entity cannot receive any requested positioning measurement from the target UE within a response duration or the network entity receives an error indication from the target UE, the network entity may terminate the on-going measurement procedure and may release any previous configurations for the on-going measurement procedure. Additionally or alternatively, the network entity may initiate a measurement reconfiguration or update procedure to the target UE, e.g., by transmitting a new location information request to the target UE.

In some embodiments, in the case that the network entity cannot receive some of the requested positioning measurement(s) from the target UE within a response duration, the network entity may indicate the target UE to terminate the on-going measurement procedure between the target UE and each error anchor UE which fails to provide the requested positioning measurement(s) and may release any previous configurations for the error UE(s). Additionally or alternatively, the network entity may initiate a measurement reconfiguration or update procedure to the target UE specified for the error anchor UE(s), e.g., by transmitting a new location information request to the target UE which includes an anchor measurement list including the error anchor UE(s). Alternatively, the network entity may indicate the target UE to reconfigure measurement or update measurement configuration for the error anchor UE(s).

In some embodiments, when the network entity determines to abort the on-going positioning measurement procedure associated with the target UE, the network entity may transmit an abort indication to the target UE. The network entity may further release the measurement configuration for the on-going positioning measurement procedure. In some embodiments, when the target UE receives the abort indication from the network entity, it may transmit the abort indication to corresponding anchor UE(s) to abort the associated on-going measurement procedures between the target UE and the corresponding anchor UE(s).

In some embodiments, when the target UE determines to abort at least one on-going measurement procedure between the target UE and at least one anchor UE, the target UE may transmit an abort message including at least one ID associated with the at least one on-going measurement procedure to the at least one anchor UE. Alternatively or additionally, the target UE may notify the network entity of this. Upon receiving the abort message from the target UE, the network entity may release the previous configuration(s) for the at least one on-going measurement procedure. In some embodiments, the at least one on-going measurement procedure to be aborted may be per SL unicast link, per SL destination, or per QoS requirement for positioning service. The at least one ID associated with the at least one on-going measurement procedure may include an link ID, a layer 2 ID, a destination ID, a pre-defined index, etc.

In some embodiments, when an anchor UE determines to abort an on-going measurement procedure between the anchor UE and the target UE, the anchor UE may transmit an abort indication to the target UE. In some embodiments, the on-going measurement procedure may be per SL unicast link, per SL destination, or per QoS requirement for positioning service. In some embodiments, the abort indication includes an ID (e.g., link ID, a layer 2 ID, a destination ID, a pre-defined index, etc.) associated with the on-going measurement procedure. In some embodiments, when the target UE receives the abort indication, it may transmit the abort indication to the network entity.

### Scenario 2

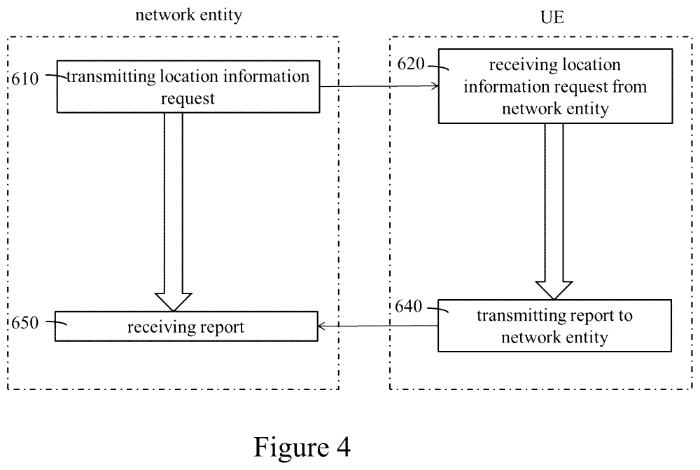

FIG. 4 illustrates a flow chart of an exemplary method 600 for SL positioning measurement and reporting in scenario 2 according to some embodiments of the present disclosure. Although method 600 performed by a UE and a network entity is illustrated in a system level, persons skilled in the art can understand that the part of method 600 implemented in the UE and the part of method 600 implemented in the network entity can be separately implemented and incorporated in other apparatus with the like functions.

Referring to FIG. 4, in operation 610, the network entity may initiate a positioning measurement procedure for obtaining location information associated with a target UE by transmitting a location information request to each of the target UE and/or a set of anchor UEs, wherein the location information request may include a measurement configuration that includes at least one positioning measurement parameter indicating requested position measurement(s). The network entity may be a BS or an LMF or other entity with similar functions.

In an embodiment, the network entity is a BS, and the first location information request is transmitted from the BS to the target UE and/or the set of anchor UEs via an RRC message. In another embodiment, the network entity is an LMF, and the first location request is transmitted from the LMF to the target UE and/or the set of anchor UEs via an LPP message.

Accordingly, in operation 620, a UE, which may be the target UE or one anchor UE of the set of anchor UEs, may receive the location information request from the network entity. Although not shown in FIG. 4, it is understood that SL-PRS transmission(s) may be performed between the target UE and the set of anchor UEs before or after the network entity transmits the location information request. The SL-PRS transmission may be from the target UE to an anchor UE or from an anchor UE to the target UE. The target UE and/or the anchor UE(s) may perform measurement based on the SL-PRS transmission(s) to obtain location information associated with the target UE.

After receiving the location information request, the UE may perform location information measurement based on the SL-PRS transmission(s) between the target UE and the anchor UE(s) according to the measurement configuration in the location information request to obtain the requested position measurement(s) indicated by the positioning measurement parameter(s) included in the measurement configuration, if the measurement configuration is compatible with a UE capability and other configuration(s) of the UE. In some embodiments, if the measurement configuration is incompatible with the UE capability or other configuration(s) of the UE, the UE will not perform location information measurement according to the measurement configuration. The measurement configuration being incompatible may include part of the measurement configuration being incompatible. In some other embodiments, when part of the measurement configuration is compatible with the UE capability and other configuration(s) of the UE while the rest is not, the UE may perform location information measurement according to the compatible part of the measurement configuration.

In operation 640, the UE may transmit a report to the network entity. Accordingly, in operation 650, the network entity may receive the report from the UE. The network entity may also receive report(s) from other UE(s) (e.g., the target UE or anchor UE(s)).

In some embodiments, the report may include at least one requested position measurement acquired by the UE. Such report may be referred to as a reporting or response message. In some embodiments, when the UE cannot acquire part of the requested position measurement(s) indicated by the measurement configuration (e.g., the part is incompatible with the UE capability or other configuration(s) of the UE, or the UE cannot acquire the part within a response duration which may be configured by the network entity via the location information request or the like or be pre-configured), the report may include both the requested position measurement(s) acquired by the UE and at least one cause value for the requested position measurement(s) not included in the report. For example, each cause value may indicate why a corresponding position measurement is not included in the report.

In some embodiments, the report may include an error indication with a cause value. Such report may be referred to as a failure or error message. The failure or error message is transmitted by the UE when at least one of the following conditions is met:
the measurement configuration is incompatible with a UE capability or other configuration(s) of the UE, or
the UE fails to acquire all or at least one of the requested position measurement(s) within a response duration (e.g., a response duration which may be configured by the network entity via the location information request or the like or be pre-configured).

In the case that the UE transmits the failure or error message, the UE may discard all the requested position measurement(s) acquired within the response duration.

In some embodiments, the network entity may start a response timer with a length corresponding to a response duration for each UE (the target UE or an anchor UE) when the network entity transmits location information request to the UE. In some embodiments, the network entity may stop the response timer for the UE when the network entity receives a report from the UE which includes at least one requested position measurement or an error indication.

In some embodiments, in the case that the network entity cannot receive any requested positioning measurement from the UE within a response duration or the network entity receives an error indication from the UE, the network entity may terminate the on-going measurement procedure associated with the UE and may release any previous configurations for the on-going measurement procedure. Additionally or alternatively, the network entity may initiate a measurement reconfiguration or update procedure to the UE, e.g., by transmitting a new location information request to the UE.

In some embodiments, when the network entity determines to release or update a positioning measurement configuration for an anchor UE, the network entity may transmit an indication to the target UE indicating the release or update of the positioning measurement configuration for the anchor UE.

In some embodiments, when the network entity determines to abort the on-going positioning measurement procedure associated with a UE (e.g., the target UE or an anchor UE), the network entity may transmit an abort indication to the UE. The network entity may further release the measurement configuration for the on-going positioning measurement procedure.

In some embodiments, when a UE (e.g., the target UE or an anchor UE) determines to abort at least one on-going measurement procedure associated with the UE (e.g., a measurement procedure between the target UE and the UE when the UE is an anchor UE or a measurement procedure between an anchor UE and the UE when the UE is the target UE), the UE may transmit an abort message including at least one ID associated with the at least one on-going measurement procedure to the network entity. Upon receiving the abort message from the UE, the network entity may release the previous configuration(s) for the at least one on-going measurement procedure. In some embodiments, the at least one on-going measurement procedure to be aborted may be per SL unicast link, per SL destination, or per QoS requirement for positioning service. The at least one ID associated with the at least one on-going measurement procedure may include an link ID, a layer 2 ID, a destination ID, a pre-defined index, etc.

In the example shown in FIG. 4, the anchor UE may transmit a report to the network entity in operation 640. In some embodiments of the present disclosure, the location information request transmitted from the network entity to an anchor UE may further indicate a reporting entity for receiving the report from the anchor UE. When the indicated reporting entity is the network entity, the anchor UE may transmit the report to the network entity. When the indicated reporting entity is the target UE, the anchor UE may transmit the report to the target UE.

In the examples shown in FIGS. 3 and 4, the network entity may initiate a positioning measurement procedure by transmitting a location information request to a target UE and/or an anchor UE and the target UE and/or the anchor UE may perform measurement reporting in response to the location information request. In some embodiments of the present disclosure, a target UE or an anchor UE may perform measurement reporting to the network entity without a request from the network entity.

In an embodiment of the present disclosure, an unsolicited location information delivery procedure for a target UE may be piggybacked in a mobile originating location request from the target UE to a network entity. The target UE may initiate a location service and send a mobile originating location request to a serving network entity for location related information for the target UE. The target UE may contain related location information (e.g., location information which may be similar to the content included in the report transmitted in operation 480 or 640) in the mobile originating location request.

In some embodiments, an unsolicited measurement reporting may be triggered when some measurement configurations are predefined in a target UE or anchor UE, or by UE implementation. For example, the target UE or anchor UE may trigger unsolicited measurement reporting when the measured RSRP value of SL-PRS between the anchor UE and the target UE reaches a specified threshold within a period of time; or when the relative distance between the target UE and the anchor UE reaches a specified threshold within a period of time, or when the measured CBR/CR value of the anchor UE reaches a specified threshold within a period of time; or when the target UE or anchor UE moves to a specific area; or when the motion trajectory of the target UE or anchor UE exceeds a certain threshold.

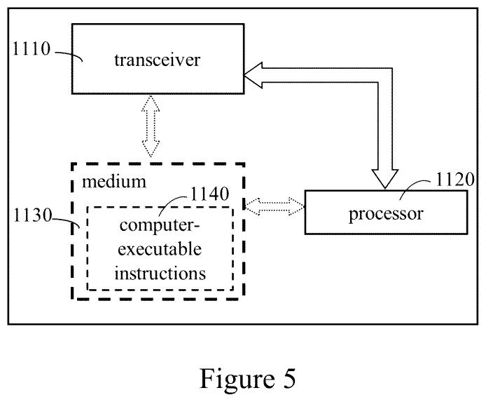

FIG. 5 illustrates a simplified block diagram of an exemplary apparatus 1100 according to various embodiments of the present disclosure. In some embodiments, the apparatus 1100 may be or include at least a part of a UE (target UE or anchor UE) or similar device having similar functionality. In some other embodiments, the apparatus 1100 may be or include at least a part of a network entity or similar device that can use the technology of the present disclosure.

As shown in FIG. 5, the apparatus 1100 may include a transceiver 1110 and a processor 1120. The transceiver 1110 may be coupled to the processor 1120. In some embodiments, the transceiver 1110 may include a transmitter and a receiver integrated together. In some embodiments, the transceiver 1110 may include a transmitter and a receiver which are separated from each other.

Furthermore, apparatus 1100 may include non-transitory computer-readable medium 1130 with computer-executable instructions 1140 stored thereon, wherein the non-transitory computer-readable medium 1130 may be coupled to the processor 1120 and the transceiver 1110. The computer-executable instructions 1140 may be configured to be executable by the processor 1120. In some embodiments, the transceiver 1110, the non-transitory computer-readable medium 1130, and the processor 1120 may be coupled to one another via one or more local buses.

Although in FIG. 5, elements such as the transceiver 1110, the non-transitory computer-readable medium 1130, and the processor 1120 are described in the singular, the plural is contemplated unless limitation to the singular is explicitly stated. In some embodiments of the present disclosure, the transceiver 1110 may be configured for wireless communication. In certain embodiments of the present disclosure, the apparatus 1100 may further include other components for actual usage.

According to some embodiments of the present disclosure, the processor 1120 may be configured to cause the apparatus 1100 at least to perform, with the transceiver 1110, any method described above, e.g., the method described with respect to any of FIGS. 1-4.

For instance, in some embodiments, the apparatus 1100 may be a target UE. The processor 1120 may be configured to perform a positioning measurement procedure to obtain location information associated with the target UE based on SL-PRS transmission(s) between the target UE and a set of anchor UEs. The transceiver 1110 may be configured to transmit a first report to a network entity based on the positioning measurement procedure.

In some embodiments, to perform the positioning measurement procedure, the processor 1120 may be configured to obtain the location information from SL-PRS measurement result(s) received from the set of anchor UEs.

In some embodiments, to perform the positioning measurement procedure, the processor 1120 may be configured to perform measurement on SL-PRS transmission(s) received from the set of anchor UEs.

In some embodiments, the transceiver 1110 may be configured to receive a first location information request from the network entity, wherein the first location information request includes a first measurement configuration that includes at least one positioning measurement parameter indicating requested position measurement(s).

In some embodiments, the first measurement configuration further includes an anchor measurement list that includes the set of anchor UEs. In some embodiments, the anchor measurement list includes all or a part of determined anchor UEs for the target UE. In some embodiments, the first measurement configuration further includes mapping relationship between each of the set of anchor UEs and the at least one positioning measurement parameter, and the transmitter is further configured to: transmit a second location information request to each of the set of anchor UEs according to the mapping relationship, wherein the second location information request transmitted to an anchor UE includes a second measurement configuration including positioning measurement parameter(s) mapped to the anchor UE.

In some embodiments, the processor 1120 is further configured to determine positioning measurement parameter(s) for each of the set of anchor UEs included in the anchor measurement list according to a pre-configuration, or a system information block, or the target UE's implementation; and the transmitter 1110 is further configured to transmit a second location information request to each of the set of anchor UEs included in the anchor measurement list, wherein the second location information request transmitted to an anchor UE includes a second measurement configuration including positioning measurement parameter(s) determined for the anchor UE.

In some embodiments, the processor 1120 is further configured to determine the set of anchor UEs and determine positioning measurement parameter(s) for each of the set of anchor UEs determined by the target UE according to a pre-configuration, or a system information block, or the target UE's implementation; and the transceiver 1110 of the target UE is further configured to transmit a second location information request to each of the set of anchor UEs determined by the target UE, wherein the second location information request transmitted to an anchor UE includes a second measurement configuration including positioning measurement parameter(s) determined for the anchor UE.

In some embodiments, the transceiver 1110 is configured to transmit the first report each time when at least one requested position measurement is received from an anchor UE of the set of anchor UEs within a response duration, wherein the first report includes the at least one requested position measurement and an ID associated with the anchor UE.

In some embodiments, the transceiver 1110 is configured to transmit the first report when a configured number of requested position measurements are received from the set of anchor UEs within a response duration.

In some embodiments, the processor 1120 is further configured to start a response timer with a length corresponding to a response duration for each anchor UE of the set of anchor UEs respectively when the second location information request is transmitted from the target UE to the respective anchor UE. In some embodiments, the processor 1120 is further configured to stop the response timer for an anchor UE of the set of anchor UEs in response to reception of a second report including at least one requested position measurement or an error indication from the anchor UE.

In some embodiments, the transceiver 1110 is further configured to receive an abort indication from the network entity to abort the positioning measurement procedure. In some embodiments, the transceiver 1110 is further configured to transmit the abort indication to the set of anchor UEs in response to the reception of the aborting indication from the network entity.

In some embodiments, the transceiver 1110 is further configured to receive at least one abort indication from at least one anchor UE of the set of anchor UEs to abort an on-going measurement procedure between the target UE and the at least one anchor UE. In some embodiments, the transceiver 1110 is further configured to transmit the at least one abort indication to the network entity.

In some embodiments, the processor 1120 is further configured to determine to abort at least one on-going measurement procedure between the target UE and at least one anchor UE of the set of anchor UEs; and the transceiver 1110 is further configured to transmit an abort message including at least one ID associated with the at least one on-going measurement procedure to at least one of the network entity or the at least one anchor UE. In some embodiments, the at least one on-going measurement procedure is per SL unicast link, per SL destination, or per QoS requirement for positioning service.

In some embodiments, the transceiver 1110 is further configured to receive an indication from the network entity indicating a release or update of a positioning measurement configuration for an anchor UE of the set of anchor UEs.

According to some embodiments of the present disclosure, the apparatus 1100 is an anchor UE. The processor 1120 is configured to perform a positioning measurement procedure to obtain location information associated with a target UE based on SL-PRS transmission(s) between the target UE and the anchor UE, and the transceiver 1110 is configured to transmit a report based on the positioning measurement procedure.

In some embodiments, to perform the positioning measurement procedure, the processor 1120 is configured to perform measurement on SL-PRS transmission(s) received from the target UE.

In some embodiments, the transceiver 1110 is configured to receive a location information request requesting the anchor UE to perform the positioning measurement procedure, wherein the location information request includes a measurement configuration including positioning measurement parameter(s) indicating requested position measurement(s); wherein the location information request is received from the target UE or from a network entity.

In some embodiments, the transceiver 1110 is further configured to receive an abort indication from a network entity or a target UE to abort the positioning measurement procedure between the target UE and the anchor UE. In some embodiments, the transceiver 1110 is further configured to transmit, to a network entity, an abort message including an ID associated with the positioning measurement procedure in the case that the abort indication is received from the target UE.

According to some embodiments of the present disclosure, the apparatus 1100 is a network entity. The transceiver 1110 is configured to receive at least one report from at least one UE, wherein the at least one report is based on a positioning measurement procedure for obtaining location information associated with a target UE based on SL-PRS transmission(s) between the target UE and a set of anchor UEs.

In some embodiments, the transceiver 1110 is configured to transmit at least one location information request to the at least one UE, wherein each location information request includes a measurement configuration that includes at least one positioning measurement parameter indicating requested position measurement(s). In some embodiments, the at least one report is received within a response duration and includes at least one of the requested position measurement(s)

In some embodiments, the processor 1120 is further configured to calculate a position result for the target UE based on the at least one report.

In some embodiments, the processor 1120 is configured to start a response timer with a length corresponding to a response duration for each UE of the at least one UE when the at least one location information request is transmitted from the network entity. In some embodiments, the processor 1120 is further configured to stop the response timer for a UE in response to reception of a report from the UE including at least one requested position measurement or an error indication.

In some embodiments, the at least one UE includes the target UE, and the measurement configuration for the target UE further includes an anchor measurement list that includes at least one anchor UE of the set of anchor UEs. In some embodiments, the measurement configuration for the target UE further includes mapping relationship between each of the at least one anchor UE and the at least one positioning measurement parameter included in the measurement configuration for the target UE.

In some embodiments, the at least one UE includes an anchor UE of the set of anchor UEs, and the location information request transmitted to the anchor UE indicates a reporting entity for receiving a report in response to the location information request from the anchor UE, wherein the location reporting entity is the network entity or the target UE.

In some embodiments, the processor 1120 is further configured to determine to abort the positioning measurement procedure; the transceiver 1110 is further configured to transmit an abort indication to the at least one UE; and the processor 1120 is further configured to release the measurement configuration for each of the at least one UE.

In some embodiments, the transceiver 1110 is further configured to receive an abort message from a UE of the at least one UE including at least one ID associated with at least one on-going measurement procedure. In some embodiments, the at least one on-going measurement procedure is per SL unicast link, per SL destination, or per QoS requirement for positioning service.

In some embodiments, the at least one UE includes an anchor UE of the set of anchor UEs; the processor 1120 is configured to determine release or update the measurement configuration for the anchor UE; and the transceiver 1110 of the network entity is further configured to transmit an indication to the target UE indicating the release or update of the measurement configuration for the anchor UE.

In some embodiments, in the case that the at least one report includes an error indication from a UE with a cause value, the processor 1120 of the network entity is configured to terminate the positioning measurement procedure and release the measurement configuration for each of the at least one UE

In various example embodiments of the present disclosure, the processor 1120 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 1120 may also include at least one other circuitry or element not shown in FIG. 5.

In various example embodiments of the present disclosure, the non-transitory computer-readable medium 1130 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 1130 may include, but is not limited to, an electric, a magnetic, an optical, an electromagnetic, an infrared, or a semiconductor system, apparatus, or device or any combination of the above.

Further, in various example embodiments of the present disclosure, the apparatus 1100 may also include at least one other circuitry, element, and interface, for example antenna element, and the like.

In various example embodiments, the circuitries, parts, elements, and interfaces in the apparatus 1100 may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A first user equipment (UE) for wireless communication, comprising:
at least one memory; and
at least one processor coupled with the at least one memory and configured to cause the first UE to:
perform a positioning measurement procedure to obtain location information associated with the first UE based on sidelink (SL) positioning reference signal (PRS) transmissions between the first UE and a set of second UEs; and
transmit a first report to a network entity based on the positioning measurement procedure.

2. The first UE of claim 1, wherein the at least one processor is further configured to cause the first UE to; receive a first location information request from the network entity, wherein the first location information request includes a first measurement configuration that includes at least one positioning measurement parameter indicating requested position measurements, and wherein the first measurement configuration further includes an anchor measurement list that includes the set of second UEs.

3. The first UE of claim 2, wherein the first measurement configuration further includes a mapping relationship between each of the set of second UEs and the at least one positioning measurement parameter, and wherein the at least one processor is further configured to cause the first UE to:
transmit a second location information request to each of the set of second UEs according to the mapping relationship, wherein the second location information request transmitted to a second UE includes a second measurement configuration including positioning measurement parameters mapped to the second UE.

4. The first UE of claim 2, wherein:
the at least one processor is further configured to cause the first UE to: determine positioning measurement parameters for each of the set of second UEs included in the anchor measurement list according to a pre-configuration, a system information block, or an implementation of the first UE; and
transmit a second location information request to each of the set of second UEs included in the anchor measurement list, wherein the second location information request transmitted to a second UE includes a second measurement configuration including positioning measurement parameters determined for the second UE.

5. The first UE of claim 3, wherein the at least one processor is further configured to cause the first UE to: transmit the first report when at least one requested position measurement is received from a second UE of the set of second UEs within a response duration, wherein the first report includes the at least one requested position measurement and an identifier (ID) associated with the second UE.

6. The first UE of claim 3, wherein the at least one processor is further configured to cause the first UE to: transmit the first report when a configured number of requested position measurements are received from the set of second UEs within a response duration.

7. The first UE of claim 6, wherein the first report includes each requested position measurement of the configured number of requested position measurements with an ID associated with a corresponding second UE from which the respective requested position measurement is received, or wherein the first report includes a location estimate determined based at least in part on the configured number of requested position measurements.

8. The first UE of claim 3, wherein the at least one processor is further configured to cause the first UE to:
start a response timer with a length corresponding to a response duration for each second UE of the set of second UEs when the second location information request is transmitted from the first UE to each second UE.

9. The first UE of claim 8, wherein the at least one processor is further configured to cause the first UE to:
stop the response timer for a second UE of the set of second UEs in response to reception of a second report including at least one requested position measurement or an error indication from the second UE.

10. The first UE of claim 3, wherein the first report includes a first error indication with a cause value when at least one of the following conditions is met:
the first UE fails to configure any of the requested position measurements for any of the set of second UEs,
the first UE receives a second error indication from each of the set of second UEs, or
the first UE fails to receive any of the requested position measurements from any of the set of second UEs within a response duration.

11. The first UE of claim 3, wherein the first report includes at least one requested position measurement received from at least one second UE of the set of second UEs within a response duration and at least one cause value for other second UEs of the set of second UEs when at least one of the following conditions is met:
the first UE fails to receive any of the requested position measurements from the other second UEs within the response duration, or
the first UE receives an error indication from any of the other second UEs.

12. A second user equipment (UE) for wireless communication, comprising:
at least one memory; and
at least one processor coupled with the at least one memory and configured to cause the second UE to:
perform a positioning measurement procedure to obtain location information associated with a first UE based on sidelink (SL) positioning reference signal (PRS) transmissions between the first UE and the second UE; and
transmit a report based on the positioning measurement procedure.

13. The second UE of claim 12, wherein the at least one processor is further configured to cause the second UE to: receive a location information request requesting the second UE to perform the positioning measurement procedure, wherein the location information request includes a measurement configuration including positioning measurement parameters indicating requested position measurement.

14. The second UE of claim 13, wherein the location information request is received from a network entity and further indicates a reporting entity for receiving the report from the second UE, and wherein the reporting entity is the network entity or the first UE.

15. A network entity for wireless communication, comprising:
at least one memory; and
at least one processor coupled with the at least one memory and configured to cause the network entity to:
receive at least one report from at least one UE, wherein the at least one report is based on a positioning measurement procedure for obtaining location information associated with a first UE based on sidelink (SL) positioning reference signal (PRS) transmissions between the first UE and a set of second UEs.

16. A processor for wireless communication, comprising:
at least one controller coupled with the at least one memory and configured to cause the processor to:
perform a positioning measurement procedure to obtain location information associated with the processor based on sidelink (SL) positioning reference signal (PRS) transmissions between the processor and a set of second UEs; and
transmit a first report to a network entity based on the positioning measurement procedure.

17. The processor of claim 16, wherein the at least one controller is further configured to cause the processor to: receive a first location information request from the network entity, wherein the first location information request includes a first measurement configuration that includes at least one positioning measurement parameter indicating requested position measurements, and wherein the first measurement configuration further includes an anchor measurement list that includes the set of second UEs.

18. The processor of claim 17, wherein the first measurement configuration further includes a mapping relationship between each of the set of second UEs and the at least one positioning measurement parameter, and wherein the at least one processor is further configured to cause the processor to:
transmit a second location information request to each of the set of second UEs according to the mapping relationship, wherein the second location information request transmitted to a second UE includes a second measurement configuration including positioning measurement parameters mapped to the second UE.

19. The processor of claim 17, wherein the at least one controller is further configured to cause the processor to: determine positioning measurement parameters for each of the set of second UEs included in the anchor measurement list according to a pre-configuration, a system information block, or an implementation of the processor; and
transmit a second location information request to each of the set of second UEs included in the anchor measurement list, wherein the second location information request transmitted to a second UE includes a second measurement configuration including positioning measurement parameters determined for the second UE.

20. The processor of claim 18, wherein the at least one controller is further configured to cause the processor to: transmit the first report when at least one requested position measurement is received from a second UE of the set of second UEs within a response duration, wherein the first report includes the at least one requested position measurement and an identifier (ID) associated with the second UE.
